(19) United States
(12) Patent Application Publication
(10) Pub. No.: US 2004/0043748 A1
(43) Pub. Date: Mar. 4, 2004

(54) Receiver and a signal processing circuit therefor

(76) Inventors: Theng Tee Yeo, Singapore (SG); Hwa Seng Yap, Singapore (SG); Masaaki Itoh, Singapore (SG)

Correspondence Address: HOWREY SIMON ARNOLD & WHITE, LLP, BOX 34, 301 RAVENSWOOD AVE., MENLO PARK, CA, 94025, US

(21) Appl. No.: 10/652,331

(22) Filed: Aug. 29, 2003

(30) Foreign Application Priority Data
Sep. 2, 2002 (SG) 200205347-8

(51) Int. Cl. H04B 1/00

(52) U.S. Cl. 455/334; 455/130

(57) ABSTRACT

A signal processing circuit arranged to be used in a frequency modulated signal receiver is disclosed which includes a complex filter 105-110 connected to analog to digital converter 112, the filter having first 105-108 and second 109,110 complex filter stages and a voltage limiter 108 disposed between the stages. The circuit is of particular applicability for use in a Bluetooth receiver.

### FIELD OF THE INVENTION

The present invention relates to a receiver suitable for a frequency modulated signal more particularly, but not exclusively applicable for use with the Bluetooth protocol.

### DESCRIPTION OF THE PRIOR ART

In most wireless transceiver integrated circuits, linearity, power consumption and production yield are the most important challenges to system and circuit design engineers. Conventional ways to overcome the linearity problem are to increase power and use AGC to slide the dynamic range. However, power is precious in today's portable electronic applications and feedback AGC architecture is too slow to respond in some applications, such as Bluetooth, which has only 4 preambles. In the Bluetooth protocol, a particular problem is the design of the dataslicer. Due to the burst mode nature, short preambles and system frequency offset of Bluetooth, the design problem of an analog data slicer becomes formidable and yield becomes a major issue. One way to overcome this is to use an advanced digital signal processing method.

A semiconductor integrated circuit which aims to overcome the problems of linearity, power and consistency has been proposed by Conexant Systems Inc. [2001 IEEE International Solid-State Circuits Conference/Session 13/Wireless LAN/13.4]. In this paper, a low IF receiver architecture is used. The RF is converted to 1 MHz IF and passed through a number of complex filter stages. Feed forward AGC with fine resolution (1˜2 dB) is used at most of the stages. The IQ outputs from the IF filter is fed to two 6 bits ADCs which operate at 10 MHz. Finally the demodulator and dataslicer are implemented in the digital domain.

By using AGC, smaller power consumption can be achieved with the feed forward structure ensuring unconditionally stability. As the final demodulation and dataslicer are implemented digitally, consistency and hence production yield can be improved with careful design of the implementation algorithm.

The receiver structure disclosed by Conexant is an improvement on prior designs. However, the structure has some redundancy and also introduces extra challenges for the circuit design engineer since the feed forward AGC with high speed response and fine resolution required in the Conexant structure is difficult to design and will have an impact on the steady state system bit error rate BER.

### SUMMARY OF THE INVENTION

According to the invention there is provided a signal processing circuit for a frequency modulated signal receiver comprising a complex filter connected to analog to digital conversion means, the filter comprising first and second complex filter stages and a voltage limiter disposed between the stages.

Preferably the first filter stage is arranged to provide gain to a received signal and may comprise at least three complex poles.

Preferably the second filter stage is arranged to filter out higher order harmonics of a received signal and may comprise at least two complex poles.

Preferably, amplifier means disposed between the second filter stage and the analog to digital conversion means and the amplifier means may comprise an automatic gain control amplifier having a signal level sensor and a controllable amplifier, with the sensor being preferably arranged to control the gain of the amplifier between two gain levels in dependence upon the level of a received signal, most preferably with the level sensor having hysterisis.

The analog to digital conversion means preferably comprises only a single analog to digital converter.

The output from the second filter stage may comprise two signals in phase quadrature, only one of which is input to the analog to digital converter means.

The circuit elements from the limiter to the analog to digital conversion means are preferably arranged to limit the signal voltage to less than the maximum allowable range of the analog to digital conversion means.

The circuit may further comprise a mixer, connected to the first filter stage, preferably via DC decoupling means.

The described embodiment has particular application in the Bluetooth standard, in which the image rejection requirement is relatively relaxed and is achievable by a five stage complex filter. No further rejection is required in the digital domain and thus the IQ phase information is no longer needed, so analog to digital conversion of either the I or Q signal is sufficient for subsequent digital processing.

### BRIEF DESCRIPTION OF THE DRAWINGS

Embodiments of the invention will now be described by way of example with reference to the accompanying drawings, in which:

FIG. 1 is a block diagram of a receiver including a processing circuit of a first embodiment of the invention;

FIG. 2 shows the structure of a complex pole of the embodiment of FIG. 1;

FIG. 3 illustrates the response of each complex pole;

FIG. 4 illustrates the combined response of all the complex poles; and

FIG. 5 illustrates a second embodiment of the invention.

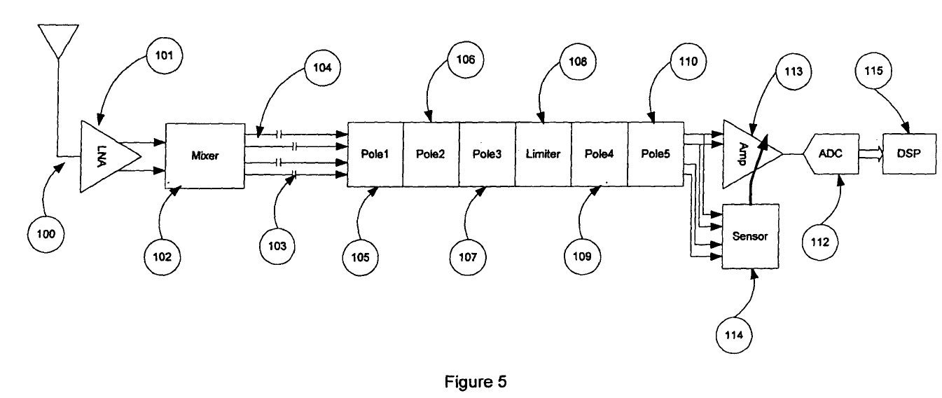

### DETAILED DESCRIPTION OF THE PREFERRED EMBODIMENTS

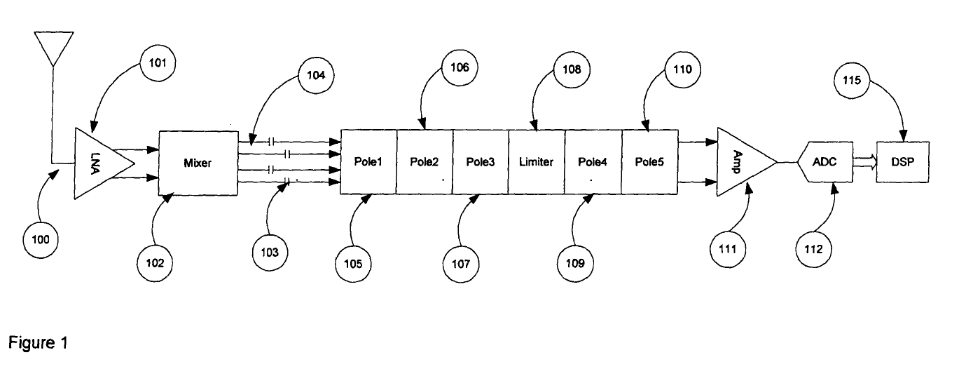

FIG. 1 is a simplified circuit diagram showing a receiving architecture according to the first embodiment of the present invention. The receiver is specifically for use with Bluetooth but is equally applicable for other frequency modulated signal applications.

An aerial 100 is connected to a LNA (low noise amplifier) 101 with a differential output, which is in turn electrically connected to a quadrature IQ mixer 102 which provides intermediate frequency (IF) I and Q outputs which are connected to a differential five pole complex filter 105, 106, 107, 108, 109, 110, 111 through coupling capacitors 103. The complex filter consists of five complex poles 105-107,109,110, a voltage limiter 108 and an amplifier 111. Gain is assigned to the first three poles 105-107, the output from the first three poles being electrically connected to the voltage limiter 108. The limiter is implemented using a hard clip topology, although soft clip can be used also. The limiter 108 is electrically connected to another two complex poles 109,110 which have insertion loss at the centre of the IF frequency. From pole 110, only the I or Q signal is electrically connected to the voltage amplifier 111. The output from the voltage amplifier 111 is electrically connected to an analog to digital convertor (ADC) 112. Finally, the ADC output is electrically connected to digital signal processing circuitry including a digital demodulator and dataslicer 115. Elements 101-112 form a single semiconductor integrated circuit receiving the signal input from aerial 100 and provided a digital signal output to digital signal processing circuitry 115, which may preferably also be built on the same IC.

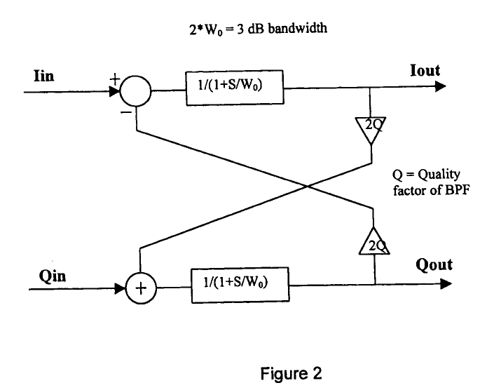

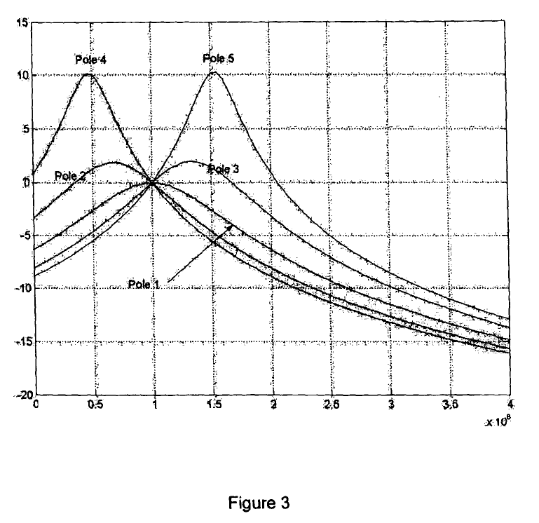

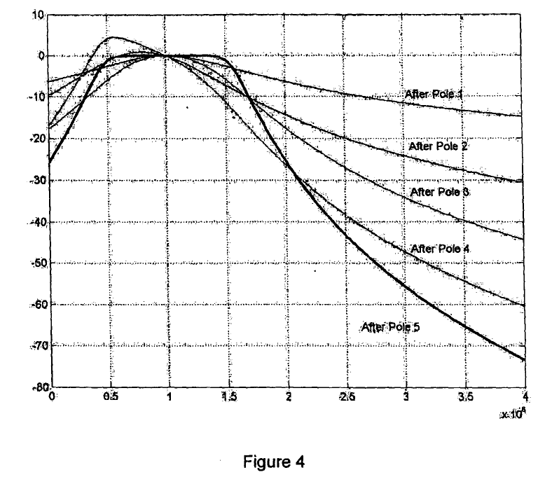

The structure of a complex pole is shown in FIG. 2. The pole receives I and Q input signals Iᵢₙ and Qᵢₙ and provides output signals Iₒᵤₜ and Qₒᵤₜ. Iᵢₙ is fed to a difference element where it is combined with Qₒᵤₜ received via an amplifier having gain 2Q, where Q is the quality factor of the complex filter pole. Qᵢₙ is fed to a summing element where it is combined with Iₒᵤₜ received via a further amplifier having gain 2Q. A transfer function 1/(1+S/W₀) is applied to the outputs from the sum and difference elements to form the outputs Iₒᵤₜ and Qₒᵤₜ. The structure of all the complex poles is the same, with the frequency response of each pole being selected by choosing Q and W₀ accordingly. As shown in FIG. 3, poles 1-3 have a relatively flat frequency response with poles 4 and 5 having much more pronounced peaks around the intermediate frequency. The combined response of all the poles is shown in FIG. 4.

The operation of the receiver in FIG. 1 will next be described. A single ended RF signal from antenna 100 or a BPF outside the semiconductor integrated circuit is input to LNA 101 and is amplified and converted to a differential RF signal. The differential RF signal is then input to the mixer 102. 1 MHz differential quadrature Intermediate Frequency (IF) I and Q signals are obtained at the output of mixer 102 and are fed to the complex filter through coupling capacitors 103. The coupling capacitors 103 cut off all the DC level in the signals at interconnect 104. The AC signals at interconnect 104 are then filtered and at the same time amplified by the first pole 105 of the complex filter. The output signals of the first pole 105 complex filter are DC connected to the next pole 106. The filtered and again amplified signals are DC connected to the next pole 107. The filtered and again amplified signals from pole 107 are then electrically connected to a voltage limiter 108. The voltage limiter ensures that the AC voltage swing of the signals is smaller or equal to a pre-designed value X. The limited outputs are then input to another two complex poles 109 and 110 with insertion loss L1 and L2 respectively. Finally, the outputs from complex pole 110 are amplified by a voltage amplifier 111 with gain G. Only one of the IQ signals from amplifier 111 are sampled by a Nyquist rate ADC 112. The ADC has a maximum input range of Y volts. The limiter range, gain/insertion loss of complex poles 109, 110 and the input range of the ADC have the following relation:

Y>=X*L1*L2*G

Typical values are X=0.5, L1=0.5, L2=0.63, G=4, Y=1

The digitized signal is then processed by the digital demodulator and dataslicer 115.

In the first embodiment as described above, the single ended RF signal from outside the semiconductor integrated circuit is converted by the LNA to differential signal without the use of a discrete BALUN which reduces the total number of discrete components. As the complex filter has finite attenuation at DC frequency, the coupling capacitors 103 help to reduce the second order effect of the LNA and mix r and also allows independent design of the common mode voltage for both mixer and complex filter. The built in gain in complex poles 105, 106 and 107 helps to improve the signal to noise ratio of the desired signal. The limiter together with the complex poles 109, 110 and amplifier 111 will ensure that the largest signal at the ADC 112 input is smaller than the ADC maximum input range. As the desired signal is frequency modulated, non-linearity at the limiter has no severe impact on the signal integrity. To allow a low sampling rate analog-digital converter (of 4 MHz sampling rate for a signal of IF=1 MHz and bandwidth 1 MHz) to be used, another two poles are added after the limiter to filter away the third and higher harmonics produced at the limiter 108 output which would otherwise be folded back to the signal band.

For a small received signal, this will experience a complete complex filter response, however for a large signal, the signal will effectively experience a limiter following by two complex poles. Hence, in principle there is no upper limit to the usable input range. The Bluetooth specification requires a receiver circuit with minimum 90 dB dynamic range. However, with architecture as describe above, a 45˜48 dB dynamic range ADC will be able to meet and exceed this requirement.

FIG. 2 shows a second embodiment of the invention being a slight modification of the embodiment of FIG. 1. The main difference is the addition of a simple one step hysterisis AGC amplifier 113,114. This AGC is placed after the complex filter chain to replace the original simple amplifier 111.

The AGC consists of two parts: namely hysterisis signal sensor 114 and a controllable two step voltage gain amplifier 113. The differential output of the complex filter chain is electrically connected to both signal sensor and two step gain control amplifier. The output of the sensor 114 is electrically connected to the control pin of the amplifier 113. The output of the amplifier is then electrically connected to the ADC 112 for further digital processing.

The operation of the second embodiment before the AGC 113,114 is exactly the same as the first embodiment. When the input signal to AGC is small, the signal sensing circuit 114 will switch the amplifier 113 to a higher gain, most preferably 24 dB and when signal is large, the circuit 113 will switch amplifier to a lower gain, most preferably 12 dB gain. The signal sensing is designed to have 6˜10 dB hysterisis to prevent frequent switching. The small signal threshold should be higher than the maximum sensitivity of the receiving system (i.e. that at which the signal level hits the signal to noise ratio to achieve the desired bit error rate) and the low gain value (12 dB) should be such that the maximum output of the ADC is less than the ADC input range. For example, if at maximum sensitivity, input to the AGC is 5 mVpp and at large signal, input to AGC is limited to 158 mVpp due to the limiter, then the low signal sensing point could be set at about 12 mVpp and high sensing point could be set to 36 mVpp (hysterisis=20log(36/12)=9.5 dB), since 12 mVpp>5 mVpp, the maximum sensitivity level and 36 mVpp * 4 (equivalent to 12 dB gain)<158 mVpp, the ADC input range limit.

In the first embodiment if the noise figure of the analog components 101-111 is fairly good, it could happen that, before maximum sensitivity is hit, the quantization noise introduced by ADC 112 is larger than the noise generated by analog components. In this case, by improving the analog circuit noise figure will not improve the sensitivity. With the simple switching AGC in FIG. 2, this effect of the quantization noise can be minimised. As the amplifier needs to switch between two different gains only, it is easier to design and with the hysterisis, there is minimum switching during communication and hence better BER.

The first embodiment has been implemented in CMOS 0.35 um technology and to meet the requirements of the Bluetooth protocol v1.x. With AGC added according to second embodiment, additional 4˜5 dB improvement in sensitivity may be achieved. For such implementations, the gain and pole assignments of the components of the described embodiment are as follows:

| LNA: | | Gain = 20 dB |
|---|---|---|
| Mixer: | | Gain = 15 dB |
| Pole1: W₀ = 2*pi*1.1e6 | Q = 0.91 | Gain = 6 dB @ 1 Mhz |
| Pole2: W₀ = 2*pi*0.89e6 | Q = 0.76 | Gain = 6 dB @ 1 Mhz |
| Pole3: W₀ = 2*pi*0.89e6 | Q = 1.5 | Gain = 6 dB @ 1 Mhz |
| Limiter: Clip voltage: | | Gain = 0 dB |
| 0.5 Vpp | | |
| Pole4: W₀ = 2*pi*0.34e6 | Q = 1.4 | Gain = −6 dB @ 1 Mhz |
| | (Low gain to maintain filter linearity) | |
| Pole5: W₀ = 2*pi*0.34e6 | Q = 4.5 | Gain = −3 dB @ 1 Mhz |
| | (Low gain to maintain filter linearity) | |
| Amplifier (1^{st} embodiment) | | Gain = 12 dB |
| ADC | Sampling Rate: | 4 Mhz |
| AGC (2^{nd} embodiment) | | Gain = 12/24 dB |

The receiving structures described in the first and second embodiments are generally applicable to all FM modulation schemes particularly using FSK/GFSK, where phase information is not critical.

1. A signal processing circuit arranged to be used in a frequency modulated signal receiver comprising a complex filter connected to analog to digital conversion means, the filter comprising first and second complex filter stages and a voltage limiter disposed between the stages.

2. A circuit as claimed in claim 1 wherein the first filter stage is arranged to provide gain to a received signal.

3. A circuit as claimed in claim 2 wherein the first stage comprises at least three complex poles.

4. A circuit as claimed in claim 1 wherein the second filter stage is arranged to filter out higher order harmonics of a received signal.

5. A circuit as claimed in claim 4 wherein the second stage comprises at least two complex poles.

6. A circuit as claimed in claim 1 further comprising amplifier means disposed between the second filter stage and the analog to digital conversion means.

7. A circuit as claimed in claim 6 wherein the amplifier means comprises an automatic gain control amplifier having a signal level sensor and a controllable amplifier.

8. A circuit as claimed in claim 7 wherein the sensor is arranged to control the gain of the amplifier between two gain levels in dependence upon the level of a received signal.

9. A circuit as claimed in claim 7 wherein the level sensor has hysterisis.

10. A circuit as claimed in claim 1 wherein the analog to digital conversion means comprises a single analog to digital converter.

11. A circuit as claim 1 wherein the output from the second filter stage comprises two signals in phase quadrature, only one of which is input to the analog to digital converter means.

12. A circuit as claimed in claim 1 wherein circuit elements from the limiter to the analog to digital conversion means are arranged to limit the signal voltage to less than the maximum allowable range of the analog to digital conversion means.

13. A circuit as claimed in claim 1 further comprising a mixer, connected to the first filter stage.

14. A circuit as claimed in claim 13 wherein the mixer is connected to the first filter stage via DC decoupling means.

15. A circuit as claimed in claim 1 wherein the circuit is arranged to be used in a Bluetooth receiver.

16. A fm receiver incorporating a circuit as claimed in claim 1.
